(19) United States
(12) Patent Application Publication
(10) Pub. No.: US 2025/0183684 A1
(43) Pub. Date: Jun. 5, 2025

(54) Short-circuit protection in a battery protection system

(71) Applicant: Zgmicro Wuxi Corporation, Wuxi Jiangsu (CN)

(72) Inventor: Hang YIN, Wuxi (CN)

(73) Assignee: Zgmicro Wuxi Corporation, Wuxi (CN)

(21) Appl. No.: 18/965,783

(22) Filed: Dec. 2, 2024

(30) Foreign Application Priority Data
Dec. 5, 2023 (CN) 202311657371.2

(51) Int. Cl. H02J 7/00

(52) U.S. Cl. CPC H02J 7/0031; H02J 7/00304; H02J 7/0047; H02J 7/0063; H02J 7/007182

(57) ABSTRACT

A short-circuit protection circuit in a battery protection system having a battery, a charge switch and a discharge switch connected in series. The short-circuit protection circuit includes: a drive unit having a first output terminal coupled to a control terminal of the discharge switch and a second output terminal coupled to a control terminal of the charge switch, and configured to output a discharge drive signal through the first output terminal to turn on or off the discharge switch, and output a charge drive signal through the second output terminal to turn on or off the charge switch; and a short-circuit detector configured to perform a short-circuit protection when the short-circuit occurs. One of the charge drive signal, the discharge drive signal and a power supply having a higher voltage is configured to supply power to the short-circuit detector.

### CROSS-REFERENCE OF RELATED APPLICATIONS

This application claims priorities of Chinese Patent Application No. 202311657371.2 filed in China on Dec. 5, 2023, the entire content of which is incorporated herein by reference.

### BACKGROUND

### Field

The subject matter described herein relates to a technical field of circuit design, and in particular to a short-circuit protection circuit in a battery protection system.

### Description of the Related Art

When a short-circuit occurs in the load of a battery system, the switch transistor in the battery circuit is typically turned off in response to the short-circuit. Specifically, this is achieved by using a short-circuit detection circuit to perform voltage detection, and the drive circuit outputs a control signal to turn off the switch transistor. The short-circuit detection circuit is powered by the battery voltage, filtered through an RC circuit to produce the supply voltage VCC. When there is no short-circuit, the drive circuit pulls up its output control signal, keeping the switch transistor in the on state.

However, when a short-circuit occurs in the load of the battery system, before the short-circuit protection is triggered, the large discharge current causes a significant sudden drop in the output voltage of the battery's positive/negative terminals due to the internal resistance of the battery cell. Although RC filtering can slightly delay the VCC voltage relative to the positive terminal voltage of the power supply, increasing the resistance and capacitance values of the RC filter to enhance this delay effect would lead to higher component costs. As a result, the delay effect that RC filtering can achieve for VCC relative to the power supply's positive terminal is very limited. When the short-circuit protection delay time is set too long, VCC may drop to the potential of the power supply's positive terminal before the short-circuit protection is triggered. If the power supply's positive terminal potential is reduced to a level where the short-circuit detection circuit cannot function properly due to the voltage drop caused by the short-circuit current across the cell's internal resistance, there is a risk of short-circuit protection failure, which could result in device damage.

Additionally, because the drive circuit needs to pull up its output control signal, the component responsible for pulling up the output control signal has a parasitic body diode between the output control signal node and the battery's positive terminal. Therefore, when a short-circuit causes VCC to drop significantly along with the battery's positive terminal voltage, the output control signal will also follow VCC and drop due to the forward conduction of the aforementioned diode. This may result in the discharge control transistor not turning off completely, increasing the risk of device damage. Therefore, it is desired to have an improved technical solution to overcome the above problems.

### SUMMARY

This disclosure discloses a short-circuit protection circuit in a battery protection system that can solve the above technical problems.

According to an aspect, the short-circuit protection circuit includes a first switch; a unidirectional conduction circuit; a voltage detection unit, a short-circuit detection unit (short-circuit detector); and a drive unit (a driver). The unidirectional conduction circuit Includes an input terminal and an output terminal. The short-circuit detector includes a power supply terminal coupling to a power supply through the first switch and coupling to the output terminal of the unidirectional conduction device

The drive unit is configured to generate a discharge drive signal in response to a discharge control signal, and output the discharge drive signal via an output terminal to turn on or off a discharge switch, the output terminal of the drive unit coupled to the input terminal of the unidirectional conduction device; a short-circuit detector configured to detect whether a short-circuit occurs, and perform a short-circuit protection when the short-circuit occurs; and a voltage detector configured to monitor the power supply's voltage, and output a valid power-down control signal to turn off the first switch when the power supply's voltage is lower than the voltage of the discharge drive signal.

According to another aspect, the short-circuit protection circuit in a battery protection system includes a battery and a discharge switch and a charge switch connected in series in a charging/discharging loop of the battery. The short-circuit protection circuit comprises: a drive unit comprising a first output terminal coupled to a control terminal of the discharge switch and a second output terminal coupled to a control terminal of the charge switch, and configured to output a discharge drive signal through the first output terminal to turn on or off the discharge switch, and output a charge drive signal through the second output terminal to turn on or off the charge switch; and a short-circuit detector configured to detect whether a short-circuit occurs, and perform a short-circuit protection when the short-circuit occurs; wherein one of the discharge drive signal and a power supply having a higher voltage is configured to supply power to a power supply terminal of the short-circuit detector, or one of the charge drive signal and the power supply having a higher voltage is configured to supply power to the power supply terminal of the short-circuit detector, or one of the discharge drive signal, the charge drive signal, and the power supply having a higher voltage is configured to supply power to the power supply terminal of the short-circuit detector.

When a short-circuit occurs in a load of the battery system, before triggering a short-circuit protection, a power supply is provided for the short-circuit detector, so that the short-circuit detector can work normally, and the risk of short-circuit protection failure and device burnout is reduced. Moreover, circuits of drive unit or drive circuit are improved so that the charge switch or discharge switch in a charging/discharging loop of the battery is ensured to be completely conducted through the design of the pull-up path, so that the risk of device burnout is reduced.

These and other features, aspects, and advantages of the subject matter will be better understood with regards to the following description, appended claims, and accompanying drawings.

### BRIEF DESCRIPTION OF THE DRAWINGS

To make the technical solutions in the embodiments of this application clearer, the accompanying drawings used in the description are briefly introduced below. The following figures are illustrative:

FIG. 1 shows a schematic diagram of a first conventional short-circuit protection circuit;

FIG. 2 shows a schematic diagram of a drive circuit related to short-circuit protection in a conventional drive unit;

FIG. 3 shows a schematic diagram of a second conventional short-circuit protection circuit;

FIG. 4 shows a schematic diagram of a third conventional short-circuit protection circuit;

FIG. 5 illustrates a schematic diagram of an equivalent circuit of a conventional battery;

FIG. 6 shows a schematic block diagram of a short-circuit protection circuit in a battery protection system according to one embodiment;

FIG. 7 illustrates a schematic diagram of an example short-circuit protection circuit in a battery protection system according to an embodiment;

FIG. 8 illustrates a schematic circuit diagram of a first embodiment of the discharge drive circuit in the short-circuit protection circuit shown in FIG. 7;

FIG. 9 illustrates a schematic circuit diagram of a second embodiment of the discharge drive circuit in the short-circuit protection circuit shown in FIG. 7;

FIG. 10 illustrates a schematic circuit diagram of a third embodiment of the discharge drive circuit in the short-circuit protection circuit shown in FIG. 7;

FIG. 11 illustrates a schematic circuit diagram of an example short-circuit protection circuit in a battery protection system according to another embodiment;

FIG. 12 illustrates a schematic diagram of a first embodiment of a charge drive circuit of the drive unit shown in FIG. 11; and

FIG. 13 illustrates a schematic diagram of a second embodiment of the charge drive circuit of the drive unit shown in FIG. 11.

### DETAILED DESCRIPTION

The detailed description is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments do not inherently indicate any particular order nor imply any limitations.

Take lithium batteries as an example, a lowest normal operating voltage range of commonly used lithium batteries is generally 2.8 volts to 3.0 volts, and a highest normal operating voltage is generally 4.2 volts to 4.25 volts. When the lithium battery is over-discharged to below 2.8 volts, it would damage the lithium battery. When the lithium battery is overcharged above 4.2 volts, it would also damage the lithium battery. In order to make lithium batteries work in a safe range of 3.0 volts to 4.2 volts, it is necessary to use a battery protection board that uses a series connection of two switches as a set of electronic switches.

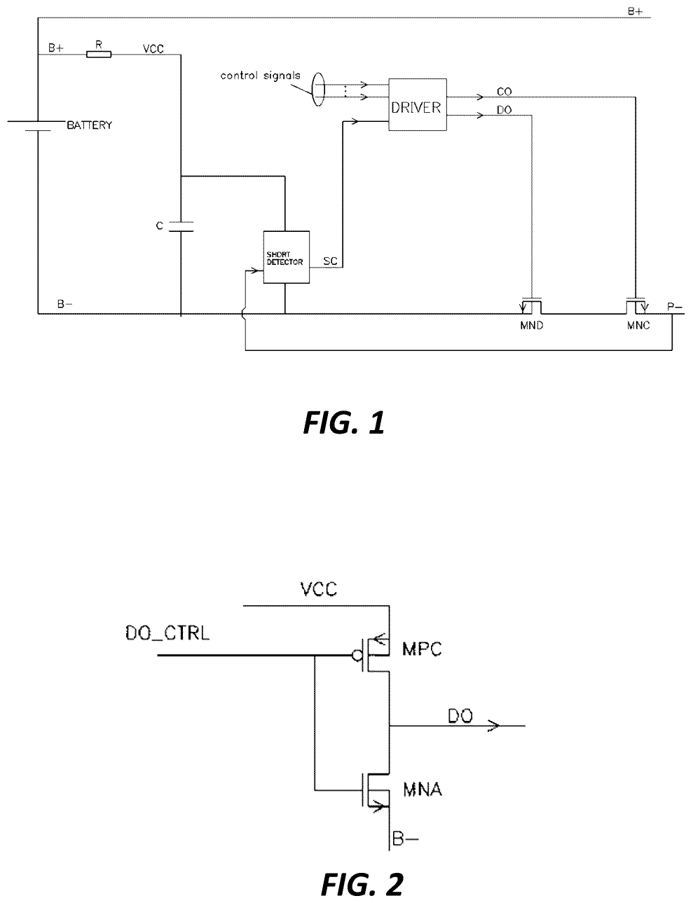

FIG. 1 shows a schematic diagram of a first conventional short-circuit protection circuit. As shown in FIG. 1, BATTERY is a battery, R is a resistor, C is a capacitor, VCC is a filtered power supply passed through a RC filter, and the power supply VCC supplies electric current to a short-circuit detector (SHORT DETECTOR). The battery may also be referred to as a battery cell. Under normal charging and discharging, a drive circuit or drive unit (DRIVER) sends out drive or control signals CO and DO at a high level to keep switches MNC and MND turned on. When a short-circuit occurred between B+/P−, a short-circuit current flows through switches MND and MNC to generate a voltage. When the short-circuit detector determines a short-circuit condition (e.g., the voltage at P− is higher than a preset short-circuit protection threshold for a specified duration), a control signal DO_CTRL is sent to the drive unit to generate drive signal DO to a low level to turn off switch MND. Drive signals CO and DO may also be referred to as switching signals or control signals.

The drive unit sends out drive signals CO, DO to control respective gates of the switches MNC, MND. The switches MNC and MND are turned off when the control gates of the switches MNC and MND are at a low level, to cut off the charging loop or the discharging loop. Switch MND is called a discharge switch, while switch MNC is called a charge switch. switch MNC Charge can be an NMOS (N-channel Metal_Oxide_Semiconductor) field effect transistor. Discharge switch MND can also be an NMOS field effect transistor. Therefore, switch MND may be referred to as a power switch transistor MND, while switch MNC as a power switch transistor MNC. B+, B− are coupled to the positive and negative terminals of the battery (BATTERY), B+, P− are ports of the battery for external voltage output or charging, VCC is the power supply. During normal operations, DO and CO are at high potential (i.e., high level, high voltage), the switches MND and MNC are turned on, and the battery can be charged and discharged.

When charging the battery, B+ and P− are coupled to positive and negative terminals of a charging device, respectively. The short-circuit detector monitors the voltage at a first terminal of the switch MNC, that is, the voltage at P−. When the voltage of the battery exceeds a preset threshold, it is determined that a short-circuit occurs between B+/P−. Control signal CO_CTRL is then sent to the drive unit to generate the drive signal CO to a low potential (i.e., low level, low voltage) to turn off the switch MNC. As a result, the charging loop is cut off, the charging device cannot charge the battery, and the battery is protected. When the short-circuit detector detects that the voltage at P− exceeds a short-circuit protection threshold for a specific duration, the drive unit generates drive signal DO to a corresponding potential to turn off the switch MND. Term “potential” is used interchangeably with “voltage level” in this disclosure. Similarly, when the battery is discharged, the short-circuit detector monitors the voltage at the first terminal of the switch MNC. When the voltage at the first terminal exceeds the short-circuit protection threshold for a specific duration, the control signal DO_CTRL is sent to the drive unit DRIVER to generate the drive signal DO to a low level to turn off the switch MND thereby cutting off the discharging loop.

FIG. 2 shows a schematic diagram of a circuit related to short-circuit protection in a conventional drive unit (DRIVER). When a short-circuit protection occurs, the short-circuit detector sends out a control signal DO_CTRL to the drive unit DRIVER. The control signal DO_CTRL is at a high level. Transistors MPC and MNA form an inverter. The transistor MPC is used for raising the level of the drive signal DO, and the transistor MNA is used for lowering the level of the drive signal DO. Terms “high” and “low” used herein are relative to high-threshold and low-threshold voltage values, respectively.

When a short-circuit protection occurs, DO_CTRL is at a high level, the transistor MNA is turned on, and the transistor MPC is turned off. The drive signal DO is at a low level corresponding to voltage at B−. As a result, switch MND is turned off. During normal operations, DO_CTRL is at a low level, the transistor MNA is turned off, and the transistor MPC is turned on. The drive signal DO is at a high level corresponding to voltage at VCC. As a result, the switch MND is turned on.

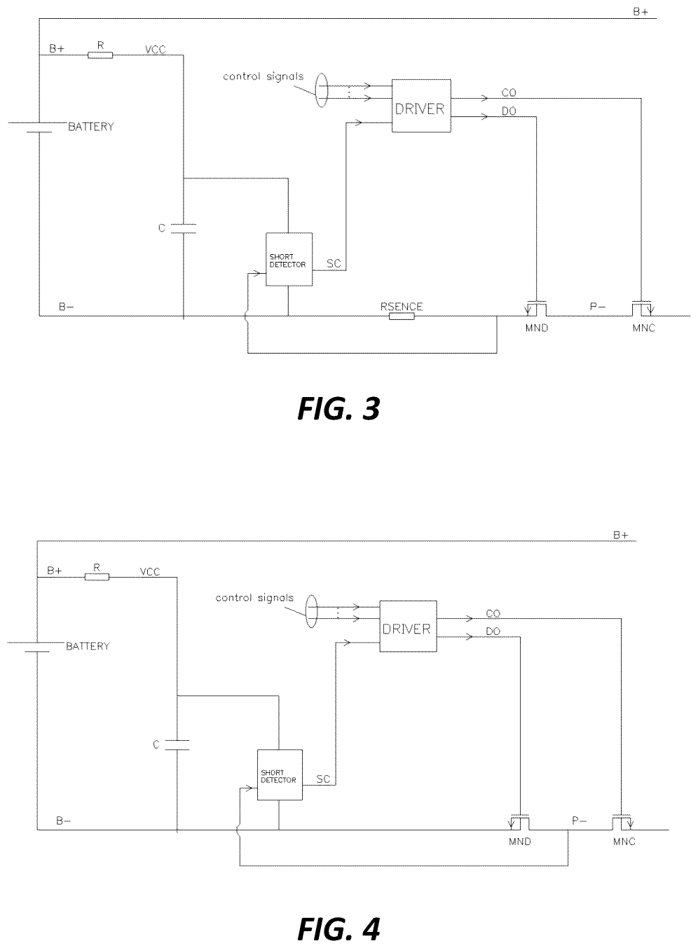

FIG. 3 shows a schematic diagram of a second conventional short-circuit protection circuit. FIG. 4 shows a schematic diagram of a third conventional short-circuit protection circuit. As shown in FIGS. 3 and 4, the short-circuit protection circuits differ from the short-circuit protection circuit shown in FIG. 1. Specifically, current detection node P− of the short-circuit detector is different. However, when the load of the battery system is short-circuited, before triggering short-circuit protection, a large discharge current would cause an output voltage between positive/negative terminals of the battery to drop sharply through an internal resistance. Although the RC filter can make the voltage VCC slightly lag behind the voltage at the positive terminal B+ of the battery, the RC filter can achieve a very limited effect of VCC lagging behind the positive terminal B+ due to higher cost caused by increase in resistance and capacitance of the RC filter. Should the specific duration for determining a short-circuit condition be set too long, the voltage VCC would drop to the voltage at the positive terminal B+ before a short-circuit protection is triggered. Should the voltage of the positive terminal B+ reduce to a level that the short-circuit detector cannot work properly, short-circuit protection would fail and a device within the batter system could burn out.

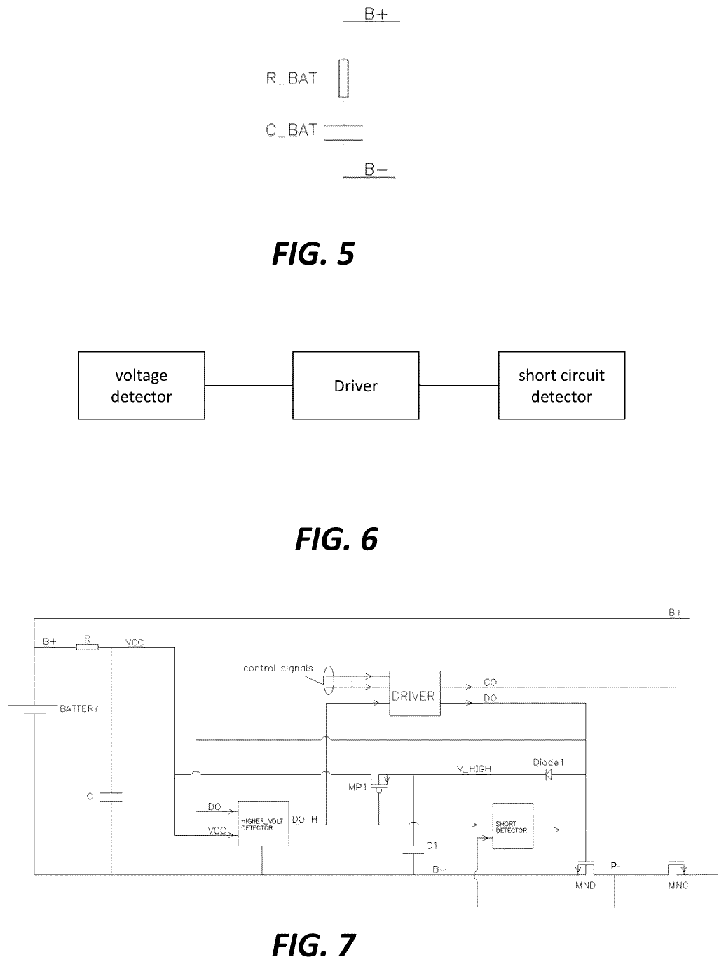

FIG. 5 is a schematic diagram illustrating an equivalent circuit of a conventional battery. The battery can be equivalent to a resistor R_BAT and a capacitor C_BAT connected in series. R_BAT is equivalent internal resistance of the battery. When the battery supplies an electric current, the electric current flowing through the internal resistance of the battery will form a voltage drop. Because the drive unit needs to raise the drive signal DO to a higher level, and elements that raise the drive signal DO, such as the transistor MPC shown in FIG. 2, includes a parasitic body diode between DO and VCC. When the short-circuit between B+/P− causes the voltage VCC follows the voltage at B+ to drop. The drive signal DO would also drop along with VCC due to the forward bias conduction of the parasitic body diode between DO and VCC. This may cause incomplete conduction of the switch MND thereby increasing the devices' burnout risk. In addition, when the load of the battery system is short-circuited, before the short-circuit protection is triggered, the large current discharge will cause a sharp drop in the voltage of the positive terminal of the battery, which may cause the failure of the short-circuit detection protection circuit. The voltage at the control gate of the discharge power switch transistor MND will also decrease with the voltage of the positive terminal of the battery, which will cause the discharge power switch transistor MND to heat up. Both of these effects increase the risk of damage when the load of the battery system is short-circuited. In order to avoid the aforementioned risk, a unidirectional conduction path is formed, so that the capacitance of the control gate of discharge switch MND is prevented from dropping when the voltage of the battery drops suddenly. The voltage in the capacitance of the control gate of discharge switch MND is utilized to maintain the voltage for normal operations of the short-circuit detector when the short-circuit occurs.

Common short-circuit protection schemes include current-limiting type, current-reduction type, turn-off type (resettable and non-resettable), etc. The short-circuit protection circuit disclosed herein improves over the turn-off type. The improved short-circuit protection circuit ca also be applicable to other types of short-circuit protection circuits. FIG. 6 is a schematic structural diagram of a short-circuit protection circuit in a battery protection system according to one embodiment. As shown in FIG. 6, the short-circuit protection circuit is applied to detection and protection of a power supply of a device such as a battery protection board, and comprises a short-circuit detection circuit (or a short-circuit detector), a drive circuit (or a driver), and a voltage detection circuit (or a voltage detector).

As shown in FIG. 7, positive terminal of the battery is coupled to power supply terminal V_HIGH of short-circuit detector (SHORT DETECTOR) via a first switch or power-down switch MP1. A voltage detector (HIGHER VOUT DETECTOR) is configured to monitor the voltage at the positive terminal of the battery (or the power supply VCC). The voltage detector sends out a valid power-down control signal DO_H to turn off the first switch or the power-down switch MP1, when the voltage at the battery's positive terminal is lower than the voltage of discharge drive signal DO.

The drive unit is configured to output a discharge drive signal DO in response to the power-down control signal DO_H and the discharge control signal DO_CTRL for turning on or off the discharge switch MND. An output terminal of the drive unit for outputting the discharge drive signal DO is coupled to an input terminal of a unidirectional conduction device Diode1, and an output terminal of the unidirectional conduction device Diode1 is coupled to a power supply terminal V_HIGH of the short-circuit detector.

The short-circuit detector is configured to monitor the voltage at a location or node for detecting overcurrent. When the voltage at the monitored location exceeds a preset short-circuit protection threshold for a specific duration, the short-circuit detector sends out a control signal (e.g., a discharge control signal DO_CTRL) to turn off the discharge switch thereby cutting off the discharging loop from the positive terminal to the negative terminal of the battery. The monitored location may be a terminal of the discharge switch MND, and may also be a terminal of a charge switch MNC. The charge switch MNC and the discharge switch MND are connected in series. Term “battery” may also be referred to as “battery cell”.

FIG. 7 is a schematic diagram illustrating a short-circuit protection circuit in a battery protection system in accordance with an embodiment. The power supply VCC is coupled to the positive terminal B+ of the battery via a resistor in a RC filter. An invalid power-down control signal DO_H is generated in a voltage detector to turn on the first switch MP1, when the power supply's voltage VCC (i.e., the voltage at the positive terminal of the battery which is essentially equal to the power supply's voltage VCC) is higher than the voltage at a discharge drive signal DO. As a result, the current loop is on between the power supply VCC and the short-circuit detector, and the power supply's voltage VCC can supply power V_HIGH for the short-circuit detector. When the voltage of the battery reduces greatly reduced due to high-current discharge, the short-circuit detector can still operate normally.

When the power supply VCC is higher than the voltage of the discharge drive signal DO (i.e., the condition is not satisfied), the power supply VCC provides power for the short-circuit detector to ensure that the short-circuit detector operates normally. Specifically, in response to the power-down control signal DO_H, the first switch MP1 is turned on, and the power supply VCC supplies power to the power supply terminal of the short-circuit detector through the first switch MP1.

When the power supply VCC is detected to be lower than the voltage of the discharge drive signal DO (i.e., the condition is satisfied), the valid power-down control signal DO_H is generated in the voltage detector to turn off the first switch MP1. The short-circuit detector outputs a short-circuit protection or discharge control signal DO_CTRL to turn off the discharge switch MND thereby cutting off the discharging loop of the battery when a short-circuit occurs, i.e., the voltage at the monitored location exceeds a preset short-circuit protection threshold for a specific duration. The turn-off and turn-on principles of a charging loop of the battery are the same as those of the discharging loop of the battery, which will not be described here.

In one embodiment, as shown in FIG. 7, the unidirectional conduction device is diode 1. The power supply terminal V_HIGH of the short-circuit detector obtains a higher voltage through the first switch MP1 or the diode 1. That is, one of the discharge drive signal DO and the power supply VCC having a higher voltage is configured to supply power to the power supply terminal V_HIGH of the short-circuit detector. The first switch MP1, the unidirectional conduction device Diode1, the voltage detector forms a higher voltage selection circuit. The first switch MP1, the unidirectional conduction device Diode1, the voltage detector work together to select one of the discharge drive signal DO and the power supply VCC having a higher voltage to supply power to the power supply terminal V_HIGH of the short-circuit detector.

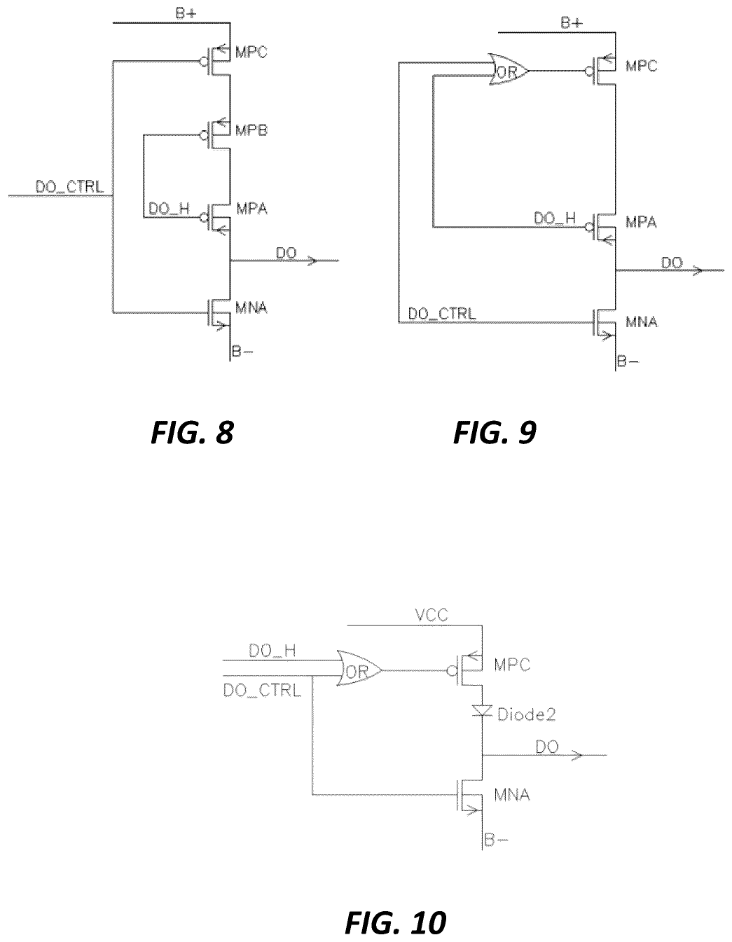

Based on the voltage at the terminal P− of the discharge switch MND away from the negative terminal B− of the battery, the short-circuit detector determines whether a short-circuit occurs or not. It should be noted that the control signals in FIG. 7 represent a series of control signals, which comprises the discharge control signal DO_CTRL in FIGS. 8, 9, and 10 and the charge control signal CO_CTRL in FIGS. 12 and 13. In one embodiment, when a discharge overvoltage or a discharge overcurrent occurs in the battery, the control signals is sent to the drive unit to generate a discharge drive signal DO at a low level to turn off the discharge switch MND, thereby cutting off the discharging loop of the battery.

In one embodiment, when the power-down control signal DO_H is at a high level, in response to the power-down control signal, the drive unit cuts off the pull-up path. The discharge drive signal DO is sent to the gate of the discharge switch MND. When the power-down control signal DO_H is at high level, the short-circuit detector is enabled. When the voltage at node P− exceeds a predetermined short-circuit protection threshold for a specific duration, the short-circuit detector sends out a short-circuit protection control signal at a low level to the gate of the discharge switch MND to turn off the discharge switch MND.

In one embodiment, the short-circuit detector is non-enabled when the potential of the power-down control signal DO_H is the potential of the negative terminal B− of the battery, that is, the power-down control signal DO_H is at a low level. Discharge drive signal DO generated in the drive unit is sent to the gate of the discharge switch MND. The power-down control signal is invalid when the power-down control signal DO_H is at low level. The power-down control signal is valid when the power-down control signal DO_H is at high level. The first switch and the discharge switch may be switching devices that are controlled to be turned on or off by logic level signals, or may be circuit modules that are controlled to be turned on or off by logic level signals.

In one embodiment, the first switch MP1 may be a PMOS field effect transistor. The PMOS (P-channel Metal_Oxide_Semiconductor) field effect transistor MP1 has a source, a drain and a gate. The source is coupled to the power supply terminal V_HIGH of the short-circuit detector. The drain is coupled to the power supply VCC. The gate is coupled to the power-down control signal DO_H from the voltage detector. The discharge switch MND is an NMOS field effect transistor. The NMOS field effect transistor MND has a source coupled to the negative terminal B− of the battery, a drain coupled to a drain of the charge switch MNC, and a gate coupled to the discharge control signal output by the short-circuit detector and the discharge drive signal DO.

The charge switch MNC and the discharge switch MND are connected in series. The charge switch MNC may be an NMOS field effect transistor. The NMOS field effect transistor MNC has a source coupled to an external port, a drain coupled to the drain of the discharge switch MND, and a gate coupling to the charge drive signal CO.

When the first switch MP1 is an NMOS transistor, the discharge switch MND, and the charge switch MNC may be NMOS transistors. For example, the discharge switch MND may also be an NPN-type triode, or may also be a load switch. Similarly, when the discharge switch MND is a PMOS transistor, the first switch MP1 may be an NMOS transistor, e.g., the first switch MP1 may also be an NPN-type triode, or may also be a load switch.

The first switch MP1 can be a PMOS transistor. The gate of the first switch MP1 is coupled to the power-down control signal DO_H. The first switch MP1 is turned on when the power-down control signal DO_H is at low level. A second terminal (drain) of the first switch MP1 is coupled to the power supply VCC, and a first terminal (source) of the first switch MP1 is coupled to the power supply terminal V_HIGH of the short-circuit detector, so that when the gate of the first switch MP1 is at low level, the power supply VCC supplies power to the power supply terminal V_HIGH of the short-circuit detector through the first switch MP1. The power supply of the short-circuit detector is ensured when the short-circuit protection does not occur.

When a short-circuit occurs between the positive terminal B+ of the battery and P−, a large current discharge causes a large drop of the voltage in the B+/B-during a long delay time before the short-circuit protection starts. Before the short-circuit protection is triggered, the power supply VCC would follow the potential of B+. When the potential of B+ drops to a level that the short-circuit detector cannot operate properly, short-circuit protection may fail and a device could burn out.

Without short-circuit between the positive terminal B+ of the battery and P−, the short-circuit detector operates normally, the signal DO_H is at low level, and the drive unit sends out the discharge drive signal DO at a high level to the gate of the discharge switch MND to turn on the discharging loop of the battery. When a fault other than short-circuit occurs, such as an overvoltage or an overcurrent, the drive unit is controlled by the discharge control signal DO_CTRL to output the discharge drive signal DO with a low level to the gate of the discharge switch MND, so that the discharge switch is turned off and the discharging loop of the battery is cut off.

When the short-circuit occurred before triggering a short-circuit protection, the voltage detector detects that the power supply's voltage VCC is lower than the voltage of the discharge drive signal DO, sends out a valid power-down control signal DO_H to turn off the first switch MP1. At this time, the discharge drive signal DO is at a high level and is coupled to the positive terminal of the diode 1, a negative terminal of the diode 1 is coupled to the power supply terminal V_HIGH of the short-circuit detector, and the first switch MP1 is turned off, so that the discharge drive signal DO is in one-way conduction with the power supply terminal V_HIGH of the short-circuit detector through the diode 1. The discharge drive signal DO supplies power to the short-circuit detector through the diode 1. When the short-circuit just occurs, the short-circuit detector has stable and reliable power supply, and the normal work of the short-circuit detector is ensured.

The short-circuit protection circuit also includes a capacitor C1. One terminal of the capacitor C1 is coupled to the first terminal of the first switch MP1 and the power supply terminal V_HIGH of the short-circuit detector, and the other terminal of the capacitor C1 is coupled to the negative terminal B− of the battery. The capacitor C1 is used for stabilizing voltage and temporarily supplying power to the short-circuit detector.

In another embodiment, the short-circuit detector monitors the voltage at a terminal of the charge switch MNC away from the negative terminal of the battery. The short-circuit protection is triggered when the voltage at the terminal of the charge switch MNC is lower than a predetermined short-circuit protection threshold for a specific duration.

In still another embodiment, the short-circuit detector monitors the voltage at a terminal of the discharge switch MND near the negative terminal of the battery. The short-circuit protection is triggered when the voltage at the terminal of the discharge switch MND is lower than a predetermined short-circuit protection threshold for a specific duration.

After the power supply problem of the short-circuit detector before the short-circuit protection is started is solved, another problem exists when the short-circuit occurs, the voltage of the positive terminal B+ of the battery drops, and the driving voltage of the gate of the discharge switch MND also drops along with the voltage of the positive terminal B+ of the battery, so that the heat of the discharge switch MND is increased, and the risk of device burnout is increased.

An improved drive unit is provided to solve the above problem. The drive unit includes a discharge drive circuit for generating the discharge drive signal DO and a charge drive circuit for generating the charge drive signal CO. It is evident that the circuits illustrated in FIGS. 8, 9, and 10 are variations of discharge drive circuit. FIG. 8 illustrates a schematic diagram of a first embodiment of a discharge drive circuit. The discharge drive circuit comprises a first MOS transistor MPC, a second MOS transistor MPB, a third MOS transistor MPA, and a fourth MOS transistor MNA connected in series. The source of the first MOS transistor MPC is coupled to the positive terminal B+ of the battery, and the drain of the first MOS transistor MPC connects to the source of the second MOS transistor MPB, the gate of the first MOS transistor MPC couples to the discharge control signal DO_CTRL. The drain of the second MOS transistor MPB connects to the drain of the third MOS transistor MPA, and the gate of the second MOS transistor MPB couples to the power-down control signal DO_H. The source of the third MOS transistor MPA connects to the drain of the fourth MOS transistor MNA, and the gate of the third MOS transistor MPA coupled to the power-down control signal DO_H. The source of the fourth MOS transistor MNA couples to the negative terminal B− of the battery, and the gate of the fourth MOS transistor MNA couples to the discharge control signal DO_CTRL.

The discharge drive circuit shown in FIG. 8 operates in the following manners. When no short-circuit occurs in the load between B+/P− and no other protection occurs that would prohibit the discharge, the power-down control signal DO_H from the voltage detector is at low potential B−, the second MOS transistor MPB and the third MOS transistor MPA are turned on, the discharge control signal DO_CTRL is at the low level, the first MOS transistor MPC is turned on, the fourth MOS transistor MNA is turned off. The discharge drive signal DO is at high potential B+, the discharge switch MND is turned on, and the battery can be charged and discharged normally. In other words, when the power supply VCC is higher than the voltage of the discharge drive signal DO. The power-down control signal DO_H is at a low level, which does not affect the discharge control signal DO_CTRL on the pull-up path and the pull-down path of the drive unit.

When a short-circuit occurs in the load between B+/P-before short-circuit protection is activated, the power supply's voltage VCC is lower than the voltage of the discharge drive signal DO, and the power-down control signal DO_H is at a high level, which is the same as that of the discharge drive signal DO. The second MOS transistor MPB and the third MOS transistor MPA are turned off. Due to the manufacturing process of MOS transistors, parasitic diodes exist in both the second MOS transistor MPB and the third MOS transistor MPA, and due to the bulk connection of the second MOS transistor MPB and the third MOS transistor MPA, reverse-biased cut-off diodes exist in both directions of the path, so that bidirectional cut-off of the path is realized. That is, when the power supply's voltage VCC is lower than the voltage of the discharge drive signal DO. The power-down control signal DO_H is at a high level to cut off the pull-up path of the discharge drive signal DO without affecting the discharge control signal DO_CTRL on the pull-down path of the discharge drive signal DO.

FIG. 9 illustrates a schematic diagram of a second embodiment of the discharge drive circuit of the drive unit shown in FIG. 7. As shown in FIG. 9, the discharge drive circuit includes an MOS transistor MPC, an MOS transistor MPA, and an MOS transistor MNA connected in series, along with an OR gate. The source of the transistor MPC couples to the positive terminal of the battery B+, the drain of the transistor MPC couples to the drain of the transistor MPA, and the gate of the transistor MPC couples to the OR gate's output port. The OR gate receives the control signal DO_CTRL from the drive unit and the signal DO_H output from the voltage detector. The source of the transistor MPA couples to the drain of the transistor MNA, and the gate of the transistor MPA couples to the power-down control signal DO_H. The source of the transistor MNA couples to the negative terminal B− of the battery, and the gate of the transistor MNA couples to the discharge control signal DO_CTRL.

The discharge drive circuit shown in FIG. 9 operates in the following manners. When no short-circuit occurs in the load between B+/P− and no other protection occurs that would prohibit the discharge, the power-down control signal DO_H is at a low level, the OR gate sends out a low-level signal by performing an “or” logic operation between DO_H and DO_CTRL, the transistor MPC is turned on, the transistor MPA is turned on, the transistor MNA is turned off, the discharge drive signal DO is at high level of the positive terminal B+ of the battery. In other words, when the power supply VCC is exceeds the voltage of the discharge drive signal DO, the power-down control signal DO_H is at low level, which does not affect the discharge control signal DO_CTRL on the pull-up path and the pull-down path of the discharge drive signal DO.

When the load coupled to B+/P− is short-circuited, the power supply's voltage VCC is lower than the voltage of the discharge drive signal DO, and the power-down control signal DO_H is at high level, which is the same as the potential of the discharge drive signal DO, both the transistor MPA and the transistor MPC are turned off, the pull-up path of the discharge drive signal DO is cut off, which does not affect the discharge control signal DO_CTRL on the pull-down path of the discharge drive signal DO.

FIG. 10 illustrates a schematic diagram of a third embodiment of the discharge drive circuit of the drive unit shown in FIG. 7. As shown in FIG. 10, the discharge drive circuit includes an MOS transistor MPC, a diode 2, and another MOS transistor MNA connected in series, along with an OR gate. The source of the transistor MPC couples to the power supply VCC, and the drain of the transistor MPC couples to the positive terminal of the diode 2. The negative terminal of the diode 2 couples to the drain of the transistor MNA. The source of the transistor MNA is coupled to the negative terminal B− of the battery.

The discharge drive circuit shown in FIG. 10 operates in the following manners. When no short-circuit occurs in the load between B+/P− and no other protection occurs that would prohibit the discharge, the discharge control signal DO_CTRL is at low level, the power-down control signal DO_H is at low level, the transistor MPC is turned on, the transistor MNA is turned off, the diode 2 conducts, and therefore the discharge drive signal DO is VCC, i.e., the high level.

When the load coupled between B+/P− is short-circuited, the power supply's voltage VCC is lower than the voltage of the discharge drive signal DO, the power-down control signal DO_H is at high level, and the OR gate sends out a signal at a high level, the transistor MPC is turned off, and the diode 2 prevents the discharge drive signal DO from backfeeding the current to the positive terminal B+ of the battery. At this time, DO_CTRL may be two states, when DO_CTRL is at high level, the transistor MNA is turned on, the discharge drive signal DO is at low level. When DO_CTRL is at a low level, the transistor MNA is turned off and the discharge drive signal DO is generated in the short-circuit detector. Specifically, DO_H is at high level to enable the short-circuit detector, and the short-circuit detector causes the signal DO to become a low level when the short-circuit protection condition is satisfied.

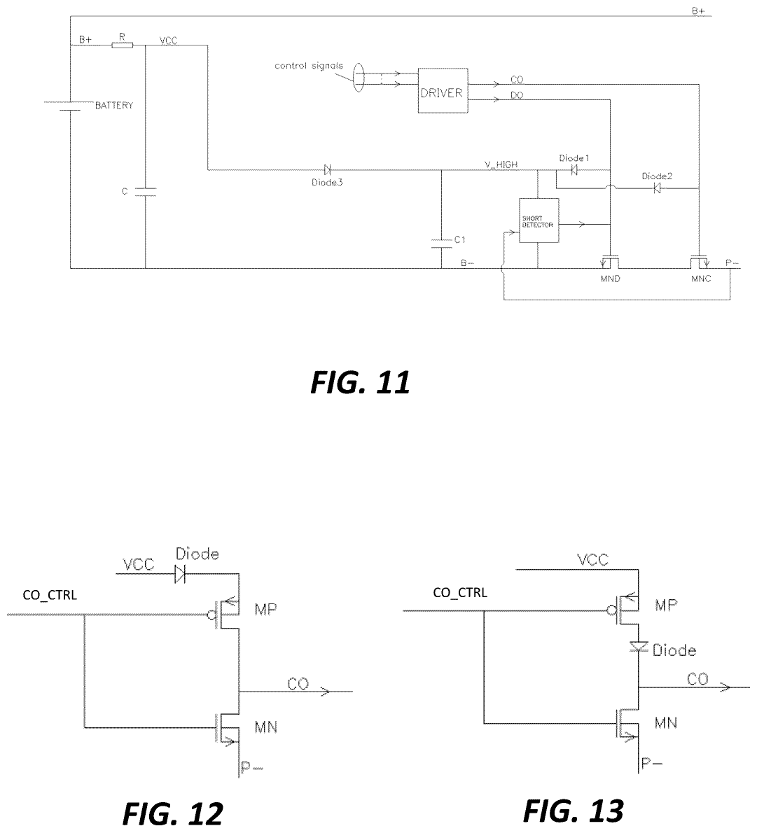

FIG. 11 illustrates a schematic diagram of an example short-circuit protection circuit in a battery protection system according to a second embodiment. As shown in FIG. 11, the battery protection system comprises a battery, a discharge switch MND and a charge switch MNC connected in series in a charging/discharging loop of the battery. The short-circuit protection circuit comprises a drive unit (DRIVER) and a short-circuit detector (SHORT DETECTOR).

The drive unit comprises a first output terminal coupling to a control terminal of the discharge switch MND and a second output terminal coupling to a control terminal of the charge switch MDC. The drive unit is configured to output a discharge drive signal DO through the first output terminal, and a charge drive signal CO through the second output terminal. The discharge switch MND is turned on or off according to the discharge drive signal, while the charge switch MNC is turned on or off according to the charge drive signal. In one embodiment. The charge switch MNC is turned on when the charge drive signal is at a high level, and the charge switch MNC is turned off when the charge drive signal is at a low level. The discharge switch MND is turned on when the discharge drive signal is at the high level, and the discharge switch MND is turned off when the discharge drive signal is at the low level.

The short-circuit detector is configured to detect whether a short-circuit occurs in the battery protection system, and to perform a short-circuit protection when the short-circuit occurs. In one embodiment, the short-circuit detector is configured to monitor the voltage of a location or node in the charging/discharging loop of the battery. The short-circuit detector determines a short-circuit occurs when the voltage at the monitored location exceeds a preset threshold for a specific duration. In one embodiment, the short-circuit detector performs short-circuit protection by turning off the discharge switch MND.

An output terminal of the short-circuit detector is coupled with the control terminal of the discharge switch MND. The short-circuit detector outputs a short-circuit protection control signal to turn off the discharge switch MND when the short-circuit occurs. The short-circuit control signal can be the discharge drive signal DO set to a high level.

One of the discharge drive signal DO, the charge drive signal CO, and a power supply VCC having a higher voltage is configured to supply power to the short-circuit detector via a power supply terminal V_HIGH. Specifically, the short-circuit protection circuit includes a higher voltage selection circuit configured to select one of the discharge drive signal DO, the charge drive signal CO, and the power supply VCC having a higher voltage to supply power to the power supply terminal V_HIGH of the short-circuit detector. The power supply VCC is coupled to the positive terminal B+ of the battery via a resistor R in a RC filter.

As shown in FIG. 11, the higher voltage selection circuit comprises: a first unidirectional conduction device (Diode 1) having an input terminal coupled to the first output terminal of the drive unit, and an output terminal coupled to the power supply terminal V_HIGH of the short-circuit detector; a second unidirectional conduction device (Diode 2) having an input terminal coupled to the second output terminal of the drive unit, and an output terminal coupled to the power supply terminal V_HIGH of the short-circuit detector; a third unidirectional conduction device (Diode 3) having an input terminal coupled to the power supply VCC, and an output terminal coupled to the power supply terminal V_HIGH of the short-circuit detector. Each unidirectional conduction device only allows electric current to flow from its input terminal to its output terminal. A positive terminal of the diode is the input terminal of the unidirectional conduction device, and a negative terminal of the diode is the output terminal of the unidirectional conduction device.

Because the gate of the discharge switch MND forms a large parasitic capacitance, when the discharge drive signal DO is at a high level, an electric energy stored in the parasitic capacitance can be used to supply power to the short-circuit detector. Similarly, the gate of the charge switch MNC also forms a large parasitic capacitance, so that when the charge drive signal CO is at a high level, the electric energy stored in the parasitic capacitance can be used to temporally supply power to the short-circuit detector.

In another embodiment, the higher voltage selection circuit may select one of the charge drive signal CO and the power supply VCC having a higher voltage to supply power to the power supply terminal V_HIGH of the short-circuit detector.

In another alternative embodiment, the higher voltage selection circuit may select one of the discharge drive signal DO and the power supply VCC having a higher voltage to supply power to the power supply terminal V_HIGH of the short-circuit detector. In the example short-circuit protection circuit shown in FIG. 7, there exists a higher voltage selection circuit formed with the first switch MP1, the unidirectional conduction device Diode1, and the voltage detector. The first switch MP1, the unidirectional conduction device Diode1, the voltage detector work together to select one of the discharge drive signal DO and the power supply VCC having a higher voltage to supply power to the power supply terminal V_HIGH of the short-circuit detector.

The short-circuit protection circuit further comprises a capacitor C1 coupled between the power supply terminal V_HIGH of the short-circuit detector and the negative terminal B− of the battery. The drive unit comprises a charge drive circuit and a discharge drive circuit. As shown in FIGS. 8, 9 and 10, the discharge drive circuit comprises a pull-up path and a pull-down path. The pull-up path is coupled between the positive terminal B+ of the battery (or the power supply VCC) and the first output terminal DO of the drive unit. The pull-down path is coupled between the first output terminal DO of the drive unit and the negative terminal B− of the battery. The pull-up path of the discharge drive circuit is provided with a first anti-reverse device being used for preventing current from flowing from the first output terminal DO of the drive unit to the positive terminal B+ of the battery when the voltage of the discharge drive signal DO is higher than voltage of the positive terminal B+ of the battery.

As shown in FIGS. 8 and 9, the first anti-reverse device is an anti-reverse switch. The anti-reverse switch is turned off when the voltage of the discharge drive signal DO is higher than the voltage at the positive terminal B+ of the battery, the anti-reverse switch is turned on when the voltage of the discharge drive signal DO is lower than the voltage at the positive terminal B+ of the battery. As shown in FIG. 8, the transistors MPB and MPA form the anti-reverse switch. As shown in FIG. 9, the transistors MPC and MPA form the anti-reverse switch.

As shown in FIG. 10, the first anti-reverse device is a unidirectional conduction device. An input terminal of the unidirectional conduction device is coupled to the positive terminal B+ of the battery, and the output terminal of the unidirectional conduction device is coupled to the first output terminal of the drive unit. As shown in FIG. 10, the unidirectional conduction device is a diode 2. The positive terminal of the diode 2 is the input terminal of the unidirectional conduction device, and the negative terminal of the diode 2 is the output terminal of the unidirectional conduction device.

FIG. 12 illustrates a schematic diagram of a first example charge drive circuit of the drive unit shown in FIG. 11. FIG. 13 illustrates a schematic diagram of a second charge drive circuit of the drive unit shown in FIG. 11.

As shown in FIG. 12 and FIG. 13, the charge drive circuit comprises a pull-up path and a pull-down path. The pull-up path is coupled between the power supply VCC and the second output terminal of the drive unit. The pull-down path is coupled between the second output terminal of the drive unit and the negative terminal B− of the battery. The pull-up path of the charge drive circuit is provided with a second anti-reverse device for preventing electric current flowing from the second output terminal of the drive unit to the power supply VCC when the voltage of the charge drive signal is higher than the power supply's voltage VCC. The pull-up path of the charge drive circuit further comprises a PMOS transistor MP, and the pull-down path of the charge drive circuit further comprises a NMOS transistor MN.

The second anti-reverse device is a unidirectional conduction device. For example, as shown in FIG. 12 and FIG. 13, the unidirectional conduction device is a diode. An input terminal of the unidirectional conduction device is coupled to the power supply VCC, and the output terminal of the unidirectional conduction device is coupled to the second output terminal of the drive unit.

The second anti-reverse device may also be an anti-reverse switch (not shown). The anti-reverse switch is turned off when the voltage of the charge drive signal CO is higher than the power supply's voltage VCC, the anti-reverse switch is turned on when the voltage of the charge drive signal CO is lower than the power supply's voltage VCC.

In the present invention, “connecting”, “connected”, “coupling”, “coupled” “couple” and other words denoting an electrical connection, if not otherwise specified, denote a direct or indirect electrical connection. Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A short-circuit protection circuit in a battery protection system having a battery and a discharge switch, the short-circuit protection circuit comprising:
a power-down switch;
a unidirectional conduction device;
a short-circuit detector coupled to a power supply through the power-down switch and coupled to the unidirectional conduction device's output terminal, the short-circuit detector generating a discharge control signal upon detecting a short-circuit in the battery protection system;
a drive unit coupled to the unidirectional conduction device's input terminal, the drive unit generating a discharge drive signal for turning on or off the discharge switch in response to the discharge control signal; and
a voltage detector coupled to the power supply, the voltage detector monitoring the power supply's voltage, and generating a power-down control signal to turn on or off the power-down switch.

2. The circuit according to claim 1, wherein the power-down control signal is set to be valid, when the power supply's voltage is lower than the discharge drive signal's voltage; wherein the short-circuit detector operates normally when the power-down control signal is invalid;
wherein the short-circuit detector is shut down when the power-down control signal is valid; and
wherein the short-circuit detector monitors a voltage of a location in the charging/discharging loop of the battery, and sends out a short-circuit protection control signal to turn off the discharge switch when the voltage at the monitored location exceeds a predetermined short-circuit protection threshold for a specific duration.

3. The circuit according to claim 2, wherein the monitored location is a terminal of the discharge switch away from the battery's negative terminal, or a terminal of a charge switch away from the battery's negative terminal, or a terminal of the discharge switch near the battery's negative terminal, and the charge switch and the discharge switch are connected in series.

4. The circuit according to claim 1, further comprising:
a resistor coupled between the power supply and the battery's positive terminal; and
a capacitor coupled between the power supply terminal of the short-circuit detector and the battery's negative terminal.

5. The circuit according to claim 1, wherein the power supply supplies power for the short-circuit detector via the power-down switch when the power-down control signal is invalid and the power-down switch is turned on; and wherein the drive unit supplies power for the short-circuit detector via the unidirectional conduction device when the power-down control signal is valid and the power-down switch is turned off.

6. The circuit according to claim 1, wherein the power-down switch comprises a P-channel Metal_Oxide_Semiconductor field effect transistor, and wherein each of the discharge switch and the charge switch comprises an N-channel Metal_Oxide_Semiconductor field effect transistor.

7. The circuit according to claim 1, wherein the drive unit comprises a pull-up path between the battery's positive terminal and the drive unit's output terminal, and a pull-down path between the drive unit's output terminal and the battery's negative terminal.

8. The circuit according to claim 7, wherein the pull-up path comprises at least two transistors connected in series, and the pull-down path comprises at least one transistor; wherein, when the power-down control signal is valid, one of the at least two transistors in the pull-up path is turned off to cut off the pull-up path, the discharge drive signal is generated in the transistor in the pull-down path; wherein, when the power-down control signal is invalid, the discharge drive signal is generated in said one of the at least two transistors in the pull-up path and the transistor in the pull-down path.

9. The circuit according to claim 7, wherein the pull-up path further comprises at least one transistor and a unidirectional conduction device connected in series, and the pull-down path comprises at least one transistor; wherein, when the power-down control signal is valid, the unidirectional conduction device path cuts off the pull-up path, the discharge drive signal is generated in the transistor in the pull-down path; when the power-down control signal is invalid, the unidirectional conduction device is turned on, the discharge drive signal is generated in both the transistor in the pull-up path and the transistor in the pull-down path.

10. The circuit according to claim 1, wherein the voltage detector comprises a comparator for comparing the power supply's voltage with the voltage of the discharge drive signal to generate the power-down control signal with a higher voltage.

11. A short-circuit protection circuit in a battery protection system having a battery, a discharge switch and a charge switch connected in series in a charging/discharging loop of the battery, the short-circuit protection circuit comprising:
a drive unit having a first output terminal coupled to a control terminal of the discharge switch and a second output terminal coupled to a control terminal of the charge switch, the drive unit configured to output a discharge drive signal through the first output terminal for turning on or off the discharge switch, and output a charge drive signal through the second output terminal for turning on or off the charge switch; and
a short-circuit detector detecting a short-circuit in the battery protection system, when the short-circuit occurs, the short-circuit detector performing a short-circuit protection using power supply from a higher voltage among the power supply, the discharge drive signal and the charge drive signal.

12. The circuit according to claim 11, further comprising:
a capacitor coupled between the power supply terminal of the short-circuit detector and the battery's negative terminal;
an output terminal of the short-circuit detector is coupled with the control terminal of the discharge switch;
a resistor coupled between the power supply and the battery's positive terminal;
wherein the charge switch is turned on when the charge drive signal is at a level higher than a high-threshold, and the charge switch is turned off when the charge drive signal is at a level lower than a low-threshold; and
wherein the discharge switch is turned on when the discharge drive signal is at a level higher than the high-threshold, and the discharge switch is turned off when the discharge drive signal is at a level lower than the low-threshold.

13. The circuit according to claim 11, further comprising:
a higher voltage selection circuit configured to select a higher voltage between the discharge drive signal and the power supply, or between the charge drive signal and having a higher voltage to supply power to the short-circuit detector, or among the discharge drive signal, the charge drive signal and the power supply;
wherein the higher voltage supplying power to the short-circuit detector;
wherein the short-circuit detector monitors a voltage of a location in the charging/discharging loop of the battery; and sends out a short-circuit protection control signal to turn off the discharge switch when the voltage at the monitored location exceeds a predetermined short-circuit protection threshold for a specific duration.

14. The circuit according to claim 13, wherein the higher voltage selection circuit comprises:
a power-down switch coupled between the power supply and the power supply terminal of the short-circuit detector;
a unidirectional conduction device coupled to the first output terminal of the drive unit with the unidirectional conduction device's input terminal, and coupled to the power supply terminal of the short-circuit detector with the unidirectional conduction device's output terminal;
a voltage detector coupled to the power supply, the voltage detector monitoring the power supply's voltage and sending out a power-down control signal to control the power-down switch, wherein, when the power supply's voltage is lower than the discharge drive signal, the power-down control signal is set to be valid for turning off the power-down switch, and wherein, when the power supply's voltage is higher than the discharge drive signal, the power-down control signal is set to be invalid for turning on the power-down switch.

15. The circuit according to claim 14, wherein the short-circuit detector operates normally when the power-down control signal is invalid, and wherein the short-circuit detector is shut down when the power-down control signal is valid.

16. The circuit according to claim 13, wherein the higher voltage selection circuit comprises:
a first unidirectional conduction device comprising an input terminal coupled to the first output terminal of the drive unit, and an output terminal coupled to the power supply terminal of the short-circuit detector;
a second unidirectional conduction device comprising an input terminal coupled to the second output terminal of the drive unit, and an output terminal coupled to the power supply terminal of the short-circuit detector; and
a third unidirectional conduction device comprising an input terminal coupled to the power supply, and an output terminal coupled to the power supply terminal of the short-circuit detector;
wherein each of the unidirectional conduction devices allows electric current flowing from respective input terminal to output terminal.

17. The circuit according to claim 16, wherein the drive unit comprises a discharge drive circuit including a pull-up path and a pull-down path, the pull-up path coupled between the power supply and the first output terminal of the drive unit, the pull-down path coupled between the first output terminal of the drive unit and the battery's negative terminal, the pull-up path including a first anti-reverse device for preventing electric current flowing from the first output terminal of the drive unit to the power supply when the discharge drive signal is higher than the power supply's voltage.

18. The circuit according to claim 17, wherein the first anti-reverse device comprises an input terminal of the first anti-reverse device coupled to the power supply, and an output terminal of the first anti-reverse device coupled to the first output terminal of the drive unit, wherein the first anti-reverse device is turned off when the discharge drive signal is higher than the power supply's voltage, and wherein the first anti-reverse device is turned on when the discharge drive signal is lower than the power supply's voltage.

19. The circuit according to claim 18, wherein the drive unit comprises a charge drive circuit including a pull-up path and a pull-down path, the pull-up path coupled between the power supply and the second output terminal of the drive unit and the pull-down path coupled between the second output terminal of the drive unit and the battery's negative terminal, the pull-up path including a second anti-reverse device for preventing electric current flowing from the second output terminal of the drive unit to the power supply when the charge drive signal is higher than the power supply's voltage.

20. The circuit according to claim 19, wherein the second anti-reverse device comprises an input terminal of the second anti-reverse device coupled to the power supply, and an output terminal of the second anti-reverse device coupled to the second output terminal of the drive unit, wherein the second anti-reverse device is turned off when the charge drive signal is higher than the power supply's voltage, and wherein the second anti-reverse device is turned on when the charge drive signal is lower than the power supply's voltage.
